(19) United States
(12) Patent Application Publication
(10) Pub. No.: US 2006/0005783 A1
(43) Pub. Date: Jan. 12, 2006

(54) Cat condo

(76) Inventor: Robert A. Larson, Fort Collins, CO (US)

Correspondence Address: JAMES RAY & ASSOCIATES, 2640 Pitcairn Road, Monroeville, PA, 15146, US

(21) Appl. No.: 10/913,749

(22) Filed: Aug. 6, 2004

Related U.S. Application Data
(60) Provisional application No. 60/585,910, filed on Jul. 6, 2004.

(51) Int. Cl. A01K 1/03

(52) U.S. Cl. 119/501

(57) ABSTRACT

A pet enclosure comprising a framework. Such framework has a predetermined configuration. There is a door framework disposed on at least one side of the framework for providing an access opening to an interior portion of the framework and a door disposed within and hingedly connected to the door framework for closing the access opening in the door frame. There is a gate hook and eye which has at least a portion thereof connected to each of a predetermined portion of the door framework and the door for securing the door in a closed position. A net like material is engageable with and covers such framework for forming the pet enclosure and ties that are engageable with each of the framework and the net like material for securing the net like material to the framework.

### CROSS REFERENCE TO RELATED APPLICATIONS

This application is closely related to and claims benefit from U.S. Provisional Application Ser. No. 60/585,910 filed Jul. 6, 2004.

### FIELD OF THE INVENTION

The present invention relates in general to an animal enclosure, and more specifically the present invention relates to a portable animal enclosure used to contain a small pet outdoors.

### BACKGROUND OF THE INVENTION

There are many times that pet owners would like to take their pet outdoors but can't do so because of various types of weather conditions. Also, many pet owners are afraid to leave their pet outdoors unattended for fear that the animal may run away or that the pet will attract other animals and possibly be harmed by them. Thus, it would be advantageous for a pet owner to have a shelter in which the pet may be placed which would not require supervision by the owner and yet the pet would be secure and still be able to enjoy being outdoors.

### SUMMARY OF THE INVENTION

The present invention provides a pet enclosure. The pet enclosure comprises a framework, such framework has a predetermined configuration. There is a door framework disposed on at least one side of the framework for providing an access opening to an interior portion of the framework and a door disposed within and hingedly connected to the door framework for closing the access opening in the door frame. There is a locking means which has at least a portion thereof connected to each of a predetermined portion of the door framework and the door for securing the door in a closed position. A net like material is engageable with and covers such framework for forming the pet enclosure and a means is engageable with each of the framework and the net like material for securing the net like material to the framework.

### OBJECTS OF THE INVENTION

It is, therefore, one of the primary objects of the present invention is to provide a enclosure to contain a pet outdoors.

Another object of the present invention is to provide an enclosure for containing a pet outdoors which is portable.

Still another object of the present invention is to provide an enclosure for containing a pet outdoors which will protect the pet from the sun.

Yet another object of the present invention is to provide an enclosure for containing a pet outdoors which will protect the pet from other animals.

Another object of the present invention is to provide a enclosure for containing a pet outdoors which will allow full air circulation.

Yet another object of the present invention is to provide a carpeted shelf in the enclosure for permitting pets to perch above the ground.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the pet enclosure according top an embodiment of the invention showing the underlying framework.

FIG. 2 is top view of the pet enclosure shown in FIG. 1 showing the shelf arrangement and the supporting members for the shelf.

FIG. 3 is a front view of the door member showing the attachment to the framework.

FIG. 4 is a perspective view from the front of a fully assembled pet enclosure showing the enclosure with the door closed according to an embodiment of the invention.

FIG. 5 is a perspective view of the completely assembled pet enclosure shown in FIG. 4 showing a cat occupying the lower level of the pet enclosure.

FIG. 6 is a perspective view of the completely assembled pet enclosure shown in FIG. 4 showing a cat occupying the upper level of the pet enclosure.

FIG. 7 is a perspective view of the side of the pet enclosure shown in FIG. 4.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

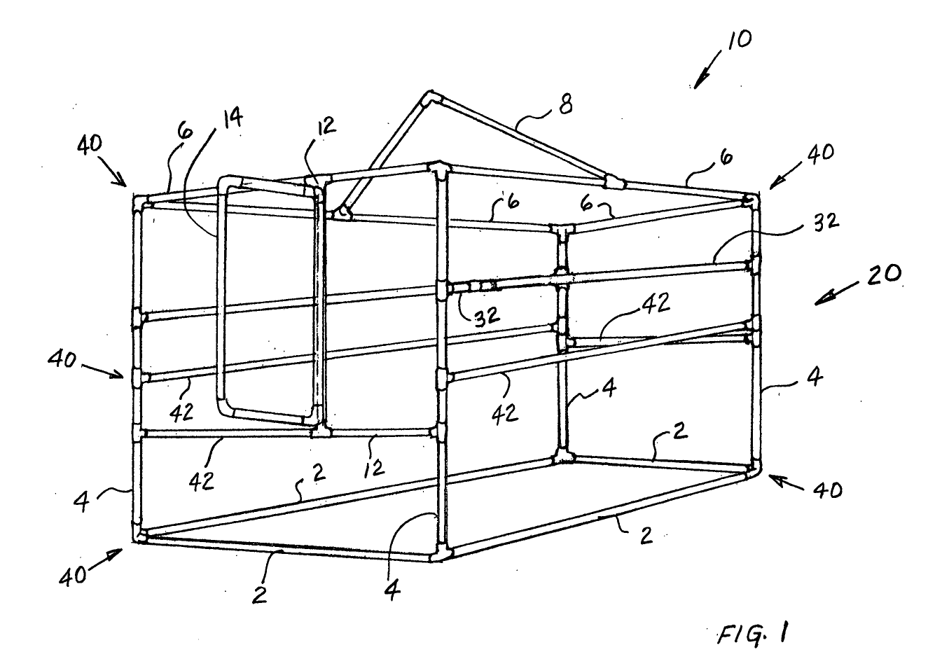

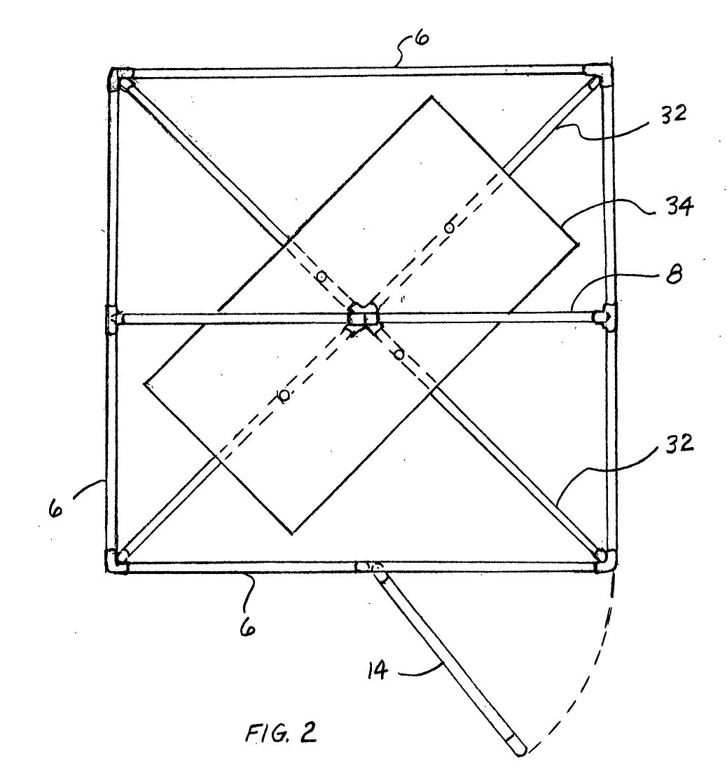

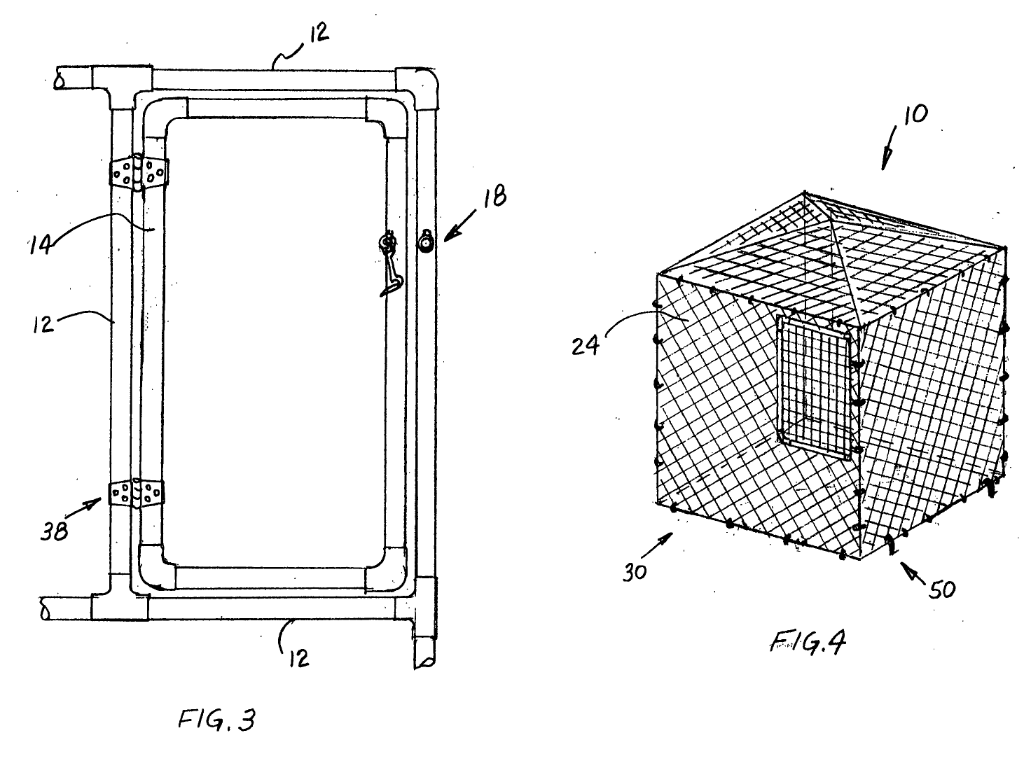

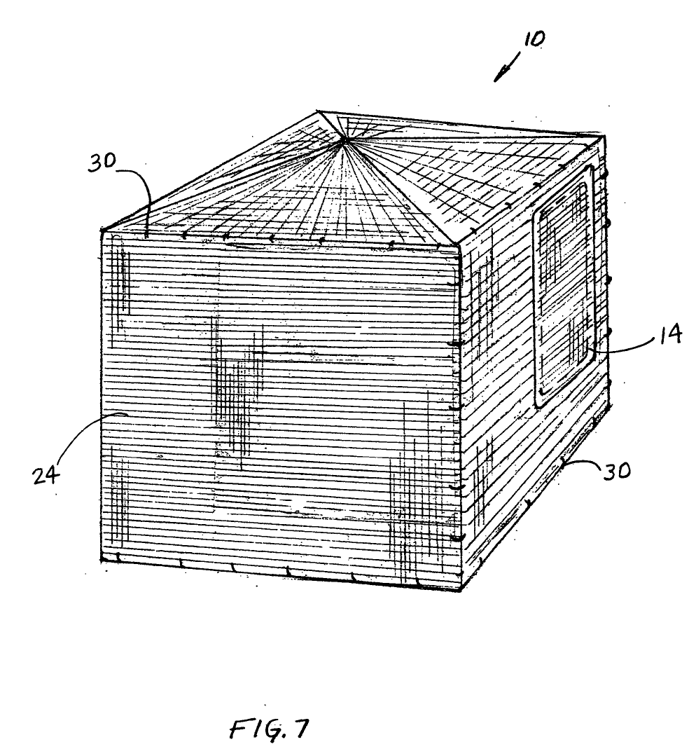

Reference is now made to FIGS. 1-7, illustrated therein is a pet enclosure, generally designated 10. Such pet enclosure 10 comprises a framework, generally designated 20, which has a predetermined configuration.

In a presently preferred embodiment on the invention such configuration is generally rectangular and particularly being in the shape of a square or more specifically having a cubic shape. This is quite evident in FIG. 1. Although it is presently preferred that such framework 20 have a square or cubic configuration and most of the discussion will be related to that configuration it is within the scope of the invention that such shape could also be a different rectangular shape, a triangular or even a circular shape, substantially in the shape of an igloo.

The framework 20 has a first predetermined plurality of substantially horizontally disposed elongated rod like base members 2 that are engageable with one another to form a predetermined geometric shape. As mentioned previously it is preferred that such geometric shape be in the form of a square and thus the predetermined plurality of base members would be four.

There is further a predetermined plurality of substantially vertically disposed elongated rod-like members 4, a first end of each of the vertically disposed elongated rod-like members 4 are engageable substantially adjacent a respective end of the horizontally disposed elongated rod-like base members 2. Again since the preferred shape of the pet enclosure is cubic there would also be four such substantially vertically disposed elongated rod-like members 4 in the preferred embodiment.

Such framework 20 also includes a second predetermined plurality of substantially horizontally disposed elongated rod like members 6 that are engageable with an axially opposed second end of the vertical elongated rod-like members 4. The second plurality of horizontally disposed elongated rod like members 6 are disposed in a plane that is substantially parallel to a plane that contains the first plurality of horizontally disposed elongated rod like base members 2.

Such framework 10 may also include various other horizontally disposed members 42 engageable with the vertical members to provide additional strength to the framework 20.

The framework 10 also has at least one elongated roof member 8 that has a predetermined configuration. Such elongated roof member 8 is engageable with the second plurality of horizontally disposed elongated rod like members 6. It is presently preferred that such roof member 8 be substantially in the shape of an inverted V.

The framework 20 also includes a door framework 12 that is disposed on at least one side of the pet enclosure 10. Such door framework 12 is disposed at a predetermined height. Such door framework 12 is formed so as to include a portion of one of the vertically disposed elongated rod members 4 and a portion of one of the substantially horizontally disposed elongated rod like members 6. The predetermined height is such that a bottom portion of such door frame 12 disposed on the framework 20 is approximately 20 inches. Thus, the door frame 12 or the bottom of the door opening is about 20 inches above the ground level. This is an easy jump for a cat.

There is a door member 14 that is disposed in the door framework 12. Such door member 14 is constructed of similar elongated rod members as is the rest of the framework 20. There is a means 38 that is disposed adjacent a first predetermined edge 16 of the door member 14 for securing the door 14 to the door framework 12. It is preferred that means 38 be strap hinges.

The door member 14 also includes a locking means 18 that has a portion thereof connected to each of the door frame 12 and the door 14 for securing the door member 14 in a closed position. This prevents the pet from accidentally pushing the door open and leaving the enclosure. It is presently preferred that such locking means 18 includes a spring loaded gate hook and an eye bolt to secure the door in a closed position.

The framework 20 of pet enclosure 10 includes an engagement means, generally designated 40, for connecting various members of the framework 20 to other members of the framework 20. It is presently preferred that such engagement means 40 includes tees and elbows. It is also preferred that such engagement means 40 also include at least one of threads, pins and adhesive to permanently or semi permanently secure such tees and elbows to such parts of the framework 20. In the presently preferred embodiment of the invention an adhesive is used to secure the parts of the framework 20 to the tees and elbows 40.

There is a net like fabric material 24 which is used for covering the framework 20. Such net like fabric material 24 provides some shade, privacy and wind protection for the pet in the enclosure and basically forms the enclosure 10. The net like fabric 24 allows for free air circulation while protecting the pet from other animals and some weather conditions although not providing complete protection from rain,

Such net like material is selected from a group including nylon, polyethylene, polypropylene and metallic screen. It is presently preferred that such fabric is polypropylene. The present invention includes a means generally designated 30, for securing such net like fabric material 24 to the framework 20. It is presently preferred that such means 30 is nylon cable ties. The net like fabric 24 is wrapped around the framework 20 and is tied to the framework with these nylon cable ties 30. The net like fabric 24 covers the entire framework including the door.

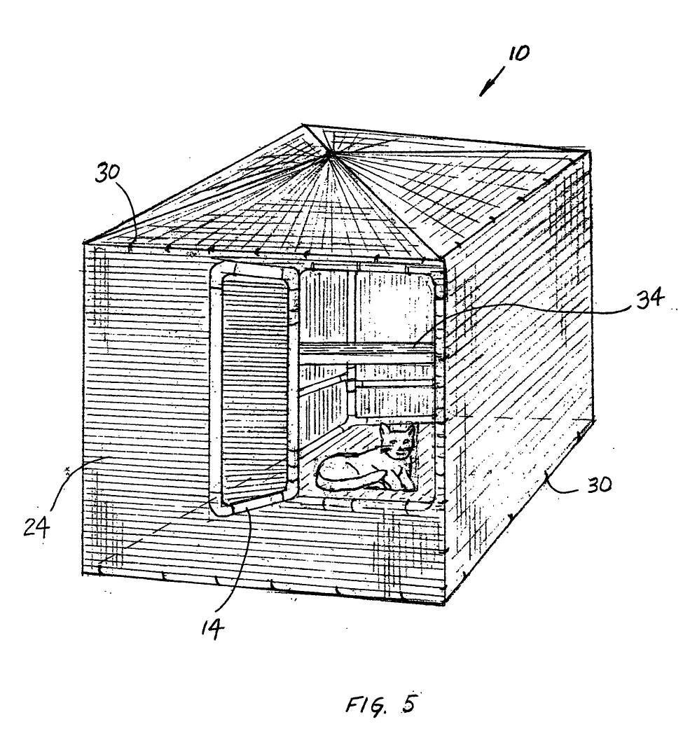

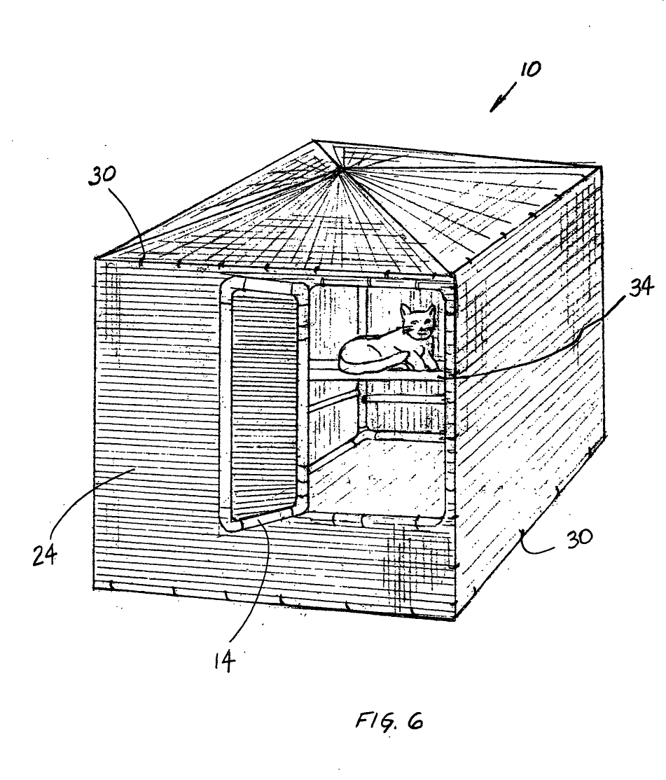

In an alternate embodiment of the invention such pet enclosure 10 also includes a pair of crosspieces 32 that are engageable with a pair of radially opposed vertically disposed elongated rod-like members 4. The pair of crosspieces 32 are disposed at substantially a midpoint on the substantially vertically disposed elongated rod-like members 4. The crosspieces 32 are added to support a shelf member 34 which is mounted on the crosspieces 32. The shelf member 34 is added to permit such pets using said pet enclosure 10 to perch above the ground. With cats this is an important feature. It is also preferred that such shelf member 34 include carpeting, as is seen in FIGS. 4 And 5, to cover the shelf. It is presently preferred that such carpeting be a carpet designed for outdoor use.

The invention also provides an optional ramp which can be used to access the shelf member 34. This would be important for an aging pet or a pet which is not very agile to have access to the shelf.

In a preferred embodiment of the invention such framework 20 is formed from a similar material. Such material is selected from a group of materials including polyvinyl chloride, acrlylonitrile butadiene styrene polymer(ABS), polypropylene, chlorinated polyvinyl chloride (CPVC) and polyethylene. It is presently preferred that such material is polyvinyl chloride. It is also presently preferred that such framework 20 be constructed of tubular sections of such polyvinyl chloride.

Such pet enclosure 10 also includes a means, generally designated 50, for securing the pet enclosure to one of the ground, patio and porch to ensure said pet enclosure remains securely in place. Such securing means 50 includes stakes, for securing the enclosure 10 to the ground and brackets, ropes or wire for securing such enclosure 10 to a porch or patio.

The pet enclosure 10 can accommodate at least several pets. The shelf member 34 is large enough for two cats.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

1. A pet enclosure utilizing one of ground, patio, and porch as a base, said pet enclosure comprising:
(a) a framework, said framework having a predetermined configuration, said framework utilizing such one of ground, patio, and porch as a base;
(b) a door framework disposed on at least one side of said framework for providing an access opening to an interior portion of said framework;
(c) a door disposed within and hingedly connected to said door framework for closing said access opening in said door frame;
(d) a locking means having at least a portion thereof connected to each of a predetermined portion of said door framework and said door for securing said door in a closed position;
(e) a net like material engageable with and covering said framework for forming said pet enclosure; and
(f) a means engageable with each of said framework and said net like material for securing said net like material to said framework.

2. The pet enclosure, according to claim 1, wherein said predetermined configuration is generally rectangular.

3. The pet enclosure, according to claim 2, wherein said predetermined configuration is substantially a square.

4. The pet enclosure, according to claim 1, wherein said framework further includes a roof portion engageable with said framework, said roof portion having a predetermined configuration.

5. The pet enclosure, according to claim 4, wherein said predetermined configuration of said roof portion is in the shape of an inverted V.

6. The pet enclosure, according to claim 1, wherein said framework further includes a pair of diagonally disposed crosspieces engageable with a pair of radially opposed substantially vertically disposed elongated rod-like members of said framework, said pair of diagonally disposed crosspieces disposed at substantially a midpoint on said substantially vertically disposed elongated rod-like members.

7. The pet enclosure, according to claim 6, wherein said pet enclosure further includes a shelf member mounted on said crosspieces to permit such pets using said pet enclosure to perch above the ground.

8. The pet enclosure, according to claim 1, wherein said framework includes an engagement means for securely connecting various vertical and horizontal members of said framework to other said vertical and horizontal members of said framework.

9. The pet enclosure, according to claim 8, wherein said engagement means includes tees and elbows.

10. The pet enclosure, according to claim 9, wherein said tees and elbows are secured by means of an adhesive.

11. The pet enclosure, according to claim 1, wherein all parts of said framework are formed from a similar material.

12. The pet enclosure, according to claim 11, wherein said all parts of said framework are formed from a group of materials including polyvinyl chloride, CPVC, ABS, polypropylene and polyethylene.

13. The pet enclosure, according to claim 12, wherein said framework is formed from polyvinyl chloride.

14. The pet enclosure, according to claim 1, wherein said locking means includes a spring loaded gate hook to secure said door in a closed position.

15. The pet enclosure, according to claim 1, wherein said net like material for covering said framework is selected from a group including polypropylene, nylon, polyethylene, and metallic screening material.

16. The pet enclosure, according to claim 15, wherein said net like material for covering said framework is polypropylene.

17. The pet enclosure, according to claim 7, wherein said shelf is carpeted with outdoor carpeting.

18. The pet enclosure, according to claim 1, wherein said net like material is secured to said framework by means of nylon ties.

19. The pet enclosure, according to claim 1, wherein said pet enclosure further includes a ramp leading to said shelf as an aid for aging and less agile pets to get to said shelf.

20. The pet enclosure, according to claim 1, wherein said pet enclosure further includes a means for securing said pet enclosure to one of ground, patio and porch to ensure said pet enclosure remains securely in place.
